(19) United States
(12) Patent Application Publication
(10) Pub. No.: US 2014/0260751 A1
(43) Pub. Date: Sep. 18, 2014

(54) Configurable Control For A Paving Machine

(71) Applicant: CATERPILLAR PAVING PRODUCTS INC., Brooklyn Park, MN (US)

(72) Inventors: Luke E. Graham, Maple Grove, MN (US); Ricky L. Mings, Andover, MN (US); Jameson Michael Smieja, Mound, MN (US)

(73) Assignee: Caterpillar Paving Products Inc., Brooklyn Park, MN (US)

(21) Appl. No.: 13/826,041

(22) Filed: Mar. 14, 2013

(51) Int. Cl. G05D 27/00

(52) U.S. Cl. CPC G05D 27/00
USPC 74/479.01

(57) ABSTRACT

An operator interface having actuators associated therewith for controlling functions of a paving machine. The operator interface includes an interactive display and a configurable lockout control associated therewith. The interactive display is enabled to allow an operator to configure the configurable lockout control by selecting at least one function that is locked out of control by an associated actuator when the lockout control is activated.

### TECHNICAL FIELD

The present disclosure relates generally to the field of paving, and relates more particularly to control systems for use in connection with paving machines.

### BACKGROUND

Hot mix asphalt material and the like may be used in road and highway construction. When properly blended in the correct proportions, the hot mix asphalt material provides a uniform and durable material that is capable of withstanding heavy traffic and loads over a long service life.

Paving machines are generally designed and used to receive, convey, distribute, profile and compact hot mix asphalt material as well as scrape, transport and recycle old asphalt material. Non-limiting examples of paving machines operable within the scope of the present disclosure include, but are not limited to cold planers, rotary mixers, pavers (including but not limited to a paver comprising a tractor/screed combination), compactors, etc.

In paving operations, a cold planer is generally used to remove or scrape up asphalt paving mats and then, in some instances, recycle the removed material for use later on. Rotary mixers are generally used for mixing the asphalt material prior to application. Pavers are generally used to lay down and profile the asphalt material. Compactors are generally used to compact and/or finish the asphalt material.

Cold planers are generally comprised of a propulsion system, a rotor and related drive mechanism, and a conveyor. Specifically, in such a configuration, the rotor generally may include tools thereon for scraping and removing asphalt material while the propulsion system moves the cold planer along the existing asphalt mat. The conveyor then conveys the material to a hopper in a separate truck, or, potentially, a unit contained on the cold planer itself. Cold planers generally have a multitude of controls associated therewith for use by an operator, some of which, depending on the application, may need to remain static for long periods of time, some of which may need to be changed relatively by the operator frequently, or on-the-fly. One exemplary, but non-limiting, embodiment of a cold planer operable for use in connection with the present disclosure, includes the Caterpillar Model No. PM201 Cold Planer.

Pavers are generally comprised of at least a tractor portion and a screed portion. Generally, the tractor portion accepts hot mix asphalt material into a receiving hopper at the front of the tractor, conveys the material from the hopper to the rear of the tractor, and distributes the hot mix asphalt material along the width of an intended ribbon or mat by means of an auger or spreading conveyors. In such a configuration, the screed portion then profiles and compacts the hot mix asphalt material into a mat. Pavers generally have a multitude of controls associated therewith for use by an operator, some of which, depending on the application, may need to remain static for long periods of time, some of which may need to be changed by the operator on-the-fly.

One exemplary, but non-limiting, embodiment of a paving machine having a screed associated therewith includes the Caterpillar Model No. AP655D Asphalt Paver. A paving machine, such as the Caterpillar Model AP655D, may include a screed apparatus mounted on a back thereof. An exemplary, non-limiting example of such a screed includes Caterpillar Model AS4252C Asphalt Screed. Screeds of this type may include screed controls, located at paving-level, allowing an operator to control various aspects of the screed operation while the paving machine is moving. In some embodiments, such as the Caterpillar Model No. AS4252C, as well as other embodiments operable within the scope of the present disclosure, dual screed controls may be provided on either side of the screed apparatus to allow an operator make changes and/or adjustments without significantly disrupting and/or slowing down the paving operation.

And while having an operator making on-the-fly adjustments, whether they be to a cold planer, rotary mixer, paver, compactor, etc., can improve the efficiency of the paving operation, it has been found, given the moving equipment and other issues at ground level (i.e. changing conditions, obstructions, etc.), that some controls can be unintentionally disrupted, changed, shut off, etc., by the operator. Such unintentional and undesired changes to operating controls can lead to problems, downtime, and sometimes require additional work and/or materials.

U.S Publication No. 2012/0263532 A1 entitled “Method and Road Paver for Laying Down a Pavement” assigned to Joseph Vogele AG describes a control system for a road paving apparatus on the basis of parameters set in the control system in advance. However, the control system described in that Vogele publication does not allow for an operator to configure specific controls on the paving machine and does not allow an operator of the paving machine, in this case screed, to lockout certain functions on an as-desired basis.

### SUMMARY

The present disclosure relates to a configurable control for a paving machine. Specifically, the present disclosure is directed to an operator interface for a control system for controlling aspects of a paving machine, and more particularly, to a cold planer, rotary mixer, paver, compactor, and/or the like. The operator interface disclosed herein provides for an operator to selectively lockout one or more functions of the paving machine so that the locked out functions are not adjusted or changed unintentionally by an operator during an operation thereof.

In one illustrative embodiment, the operator interface may include an operator interface which may control various functions of a road paving machine. In an extension of that embodiment, the operator interface may also include an interactive display that displays the status of various functions associated therewith. In an aspect of the disclosure, an operator may configure the operator interface to lockout certain functions on the operator interface such that such functions are not accidentally changed, adjusted, turned on/off, etc. while maintaining other functions in an adjustable condition for adjustments as necessary and/or desired on-the-fly.

In another illustrative embodiment, the disclosure comprises an operator interface having actuators associated therewith for controlling pre-determined functions of a paving machine. In accordance therewith, the operator interface may have an interactive display and a configurable lockout control associated therewith. In this embodiment, the interactive display may be enabled to allow an operator to configure the configurable lockout control to lockout at least one of the functions of the paving machine.

### BRIEF DESCRIPTION OF THE DRAWINGS

FIG. 1 is a right rear perspective view of an exemplary paving machine, namely a paver, comprising a tractor having a screed attachment thereon operable in accordance with embodiments of the present disclosure;

FIG. 2 is a right front perspective view of the paving machine of FIG. 1;

FIG. 3 is a front perspective view of an exemplary operator interface including an interactive display operable consistent with embodiments of the present disclosure.

### DETAILED DESCRIPTION

The present description proceeds with respect to a paver 10, having a tractor 14 and a screed apparatus 12 as shown in the drawings and as described herein. However, it should be noted that the present disclosure can be implemented in all of the other paving machines specifically disclosed, as well as other paving machines as would be apparent to a person of ordinary skill in the art.

Referring first to FIGS. 1-2, a paver 10 may be comprised of a screed apparatus 12 and a tractor 14. In an embodiment consistent with the disclosure, the tractor 14 may include an asphalt hopper 16 therein, and may include an operator control platform 17 located on the tractor 14 which may have dual operator control stations 19 for primary control of the tractor 14 functions. To assist in paving operations, the tractor 14 asphalt hopper 16 may include dual conveyors (not shown) and dual augers (not shown) as is known by those of ordinary skill in the paving art.

In one embodiment, the screed apparatus 12 may include a left operator interface 18 and a right operator interface 20 located on the screed apparatus 12 at paving-level for access by an operator located at paving-level primarily for the purposes of making adjustments to and controlling the screed apparatus 12. In an alternate embodiment of the disclosure, the screed apparatus 12 may include only a single operator interface (not shown), dual operator interfaces 18, 20, including a left operator interface 18 and a right operator interface 20 located at paving-level, or multiple operator interfaces (not shown).

An operator may thus manipulate the screed apparatus 12 using the operator interfaces 18, 20 as is known in the art. The operator interfaces 18, 20 may be provided with a control panel 29 (see FIG. 3) having a number of actuators thereon (such as push controls, potentiometers, switches, etc.) which can be manipulated by the operator to control certain functions of the screed apparatus 12 and of the tractor 14. The operator-actuable functions on the operator interfaces 18, 20 in one illustrative embodiment may provide electrical signals to a control computer which controls certain functions of the screed apparatus 12 in response to the signals received.

The screed apparatus 12 in accordance with the present disclosure may include and provide functions known by those of ordinary skill in the art to be included in paving machines and may include a left screed extender 22 and right screed extenders 24, both of which may be adjustable for height, width and slope. The screed apparatus 12 may also include height adjustable left (not shown) and right 26 towpoints.

In addition, in one illustrative embodiment, an interactive display 30 (see FIG. 3) may be provided on the operator interfaces 18, 20 for indicating certain items of information to the operator. Additional operator control may be achieved through other means, including, but not limited to through the use of a membrane keypads, touch sensitive screens, etc. Accordingly, it should be understood that while control of some of the functions discussed below are discussed with respect to specifically pre-identified function switches on the operator interfaces 18, 20, that the same or similar functionality may be achieved through the disclosed interactive display 30, or other means, all of which are considered within the scope of the disclosure.

Referring to FIG. 3, an illustrative left operator interface 18 may be comprised of a control panel 29 and an interactive display 30 and may be equipped with many different controls for screed apparatus 12 and tractor 14 functions as is known to those of ordinary skill in the art. As briefly discussed above, it is to be understood that the disclosure herein may be applied in connection with a single interface (in a single interface system), right and/or left interfaces 20, 18 (in a dual interface system), and in any one of multiple interfaces (in a multiple interface system). Thus while the interface disclosed herein is discussed only with regards to an exemplary left interface 18, it may apply to and be used in accordance with the disclosure in all of the applications discussed above.

In accordance with the foregoing, the control panel 29 on the left interface 18 in a dual operator interface may include any and/or all of the following actuators/indicators: a left main frame extension control 40; a left towpoint control 42; a right towpoint control 44; a left extender height control 46; a left extender slope control 48; a crown control 50; an auger height control 52; a left conveyor reverse control 54; a left auger reverse control 56; an emergency stop switch 58; a horn control 62; a configurable lockout control 64; and a lockout LED indicator 65.

As is known in the art, an exemplary, but non-limiting explanation of how these exemplary controls may be operated is as follows. For example, the left tractor main frame extension control 40 may be operated by an operator as follows. The operator may press the left tractor main frame extension control 40 to the left in order to extend the left tractor main frame extension (not shown) and may press the left tractor main frame extension control 40 to the right in order to retract the left tractor main frame extension (not shown). Then, when the left tractor main frame extension control 40 is released, the left tractor main frame extension (not shown) may remain in the last selected position.

The left towpoint control 42 may be used to control the left towpoint by pressing and holding the left towpoint control 42 upward in order to increase the thickness of the mat on the left side of the screed apparatus 12. Conversely, the operator may press and hold the left towpoint control 42 downward in order to decrease the thickness of the mat on the left side of the screed apparatus 12. Then, when the left towpoint control 42 is released, the left towpoint (not shown) may remain in the last selected position.

Similarly, the right towpoint control 44 may be used to control the right towpoint 26 by pressing and holding the right towpoint control 44 upward in order to increase the thickness of the mat on the right side of the screed apparatus 12. Conversely, the operator may press and hold the right towpoint control 44 downward in order to decrease the thickness of the mat on the right side of the screed apparatus 12. Then, when the right towpoint control 44 is released, the right towpoint 26 may remain in the last selected position.

Similarly, the left extender height control 46 may be used to control the left screed extender 22 height by pressing and holding the left extender height control 46 upward in order to increase the thickness of the mat on the left side of the screed apparatus 12. Conversely, the operator may press and hold the left extender height control 46 downward in order to decrease the thickness of the mat on the left side of the screed apparatus 12. Then, when the left extender height control 46 is released, the left screed extender 26 may remain in the last selected position.

The left extender slope control 48 may be operated by the operator as follows. The operator may press the left extender slope control 48 up in order to decrease the downward slope of the left screed extender 22 and may press the left extender slope control 48 down in order to increase the downward slope of the left screed extender 22. Then, when the left extender slope control 48 is released, the left screed extender 22 slope may remain in the last selected position.

The crown control 50 may be operated by the operator as follows. The operator may press the crown control 50 up in order to decrease the angle of positive crown of the mat and may press the crown control 50 down in order to increase the positive crown of the mat. Then, when the crown control 50 is released, the crown control 50 may remain in the last selected position.

The auger height control 52 may be operated by the operator as follows. The operator may press the auger height control 52 up in order to raise the height of the auger and may press the auger height control 52 down in order to lower the height of the auger. Then, when the auger height control 52 is released, the auger height may remain in the last selected position.

The left conveyor reverse control 54 may be operated by pressing the left conveyor reverse control 54 to reverse the direction of the conveyor. Similarly, the left auger reverse control 56 may be operated by pressing the left auger reverse control 56 to reverse the direction of the auger.

In accordance with an aspect of the disclosure, an operator, once setting the various controls for the functions discussed above to a desired setting, may wish to lockout those settings from accidentally being changed during on-the-fly adjustments of other controls on the operator interface 18. This may be particularly true of paving-level operator interfaces that are particularly susceptible to accidental changes or adjustments due to the fact that the operator may be moving along with the paver 10 and may have to deal with environmental issues (such as rain, snow, sleet, heat, etc.) and/or topographic issues (such as manholes, traffic, curbs, etc.). Furthermore, depending on the application, some controls for specific functions may be desired to be changed on-the-fly, while others may be desired to be maintained once set. Importantly, the controls for certain functions that may be desired to not be changed once set may change on an application-to-application or on an operator-by-operator basis.

Thus, in accordance with the present disclosure, a configurable lockout control 64 may be provided. The configurable lockout control 64 in accordance herewith may be provided as a separate control on the operator interface 18 and, in accordance therewith, may be an on/off control. In accordance with another embodiment of the disclosure, the configurable lockout control 64 may be provided through the use of a membrane keypad, a touch sensitive screen, etc. that may or may not be located on the interactive display 30. In accordance with an embodiment, the interactive display 30 may be used by an operator to configure a list of controls and/or functions that may be selectively locked out by the configurable lockout control 64. In accordance with another embodiment of the present disclosure, technician-only software could be used to configure a list of controls and/or functions that may be selectively locked out by the configurable lockout control 64 as-needed basis.

In accordance with an embodiment of the disclosure, an LED indicator 65 may be provided in proximity to the configurable lockout control 64 on the operator interface 18 to indicate whether the lockout is active or inactive. In other embodiments in accordance herewith, lockout activation may be indicated by an indicator on the interactive display 30.

A configurable lockout control 64 in accordance with an aspect of a disclosure may be configured to lockout any desired control and/or function of a paver 10, including any control and/or function of a screed apparatus 12 and/or tractor 14. Specifically, in accordance with at least one aspect of the disclosure, a list of functions and/or controls that may be selected to be locked out by an operator may include, but is not limited to: a right and/or left tractor main frame extension control 40; a left towpoint control 42; a right towpoint control 44; a right and/or left extender height control 46; a right and/or left extender slope control 48; a crown control 50; an auger height control 52; a left conveyor reverse control 54; a left auger reverse control 56; etc.

In accordance with an embodiment of the disclosure, the configurable lockout control 64 may be configured such that the functionality thereof is disabled until an operator configures the functionality of the control 64. In such an embodiment wherein the configurable lockout control 64 has not been configured, pressing of the configurable lockout control 64 will have no effect on any functions of the paver 10 and/or screed apparatus 12. More specifically, upon pressing or attempting to control a locked-out control, no movement or activation will occur at the function related to that control. Upon deactivation of the lockout control 64, functionality to the locked-out control is restored.

In accordance with one embodiment of the disclosure, an operator may activate the interactive display 30 and select which functions the operator wishes to be locked out by the configurable lockout control 64. In accordance with one aspect of this embodiment, after making such selections, the operator may be provided with the ability to save the selected configuration as an operator-specific profile. In accordance with this embodiment, the operator may then choose to activate the operator's own specific profile, a previously saved configuration, or the profile of another operator. At this point, the configurable lockout control 64 is activated and activation of the control 64 will lockout the selected functions. Conversely, when the configurable lockout control 64 is deactivated, all of the controls and/or associated functions on the operator interface 18 are available for control and/or manipulation by the operator.

In an embodiment of the disclosure where lockout configurations are not saved in an operator profile, the lockout configurations may be saved from key cycle to key cycle and then altered by each operator as circumstances or operator preferences warrant. Conversely, in another embodiment in accordance with the disclosure, lockout configurations may be cleared from key cycle to key cycle necessitating operator selection of desired configuration upon each new key cycle. In yet another embodiment in accordance with the disclosure, multiple lockout configurations may be saved and may be selected by an operator at the beginning of a key cycle. In connection with any of these embodiments, a default configuration may be provided which can then be changed to an operator-specific profile, another saved configuration, or separately modified as situation and/or circumstance warrant.

In one embodiment of the disclosure, once a configuration is saved to an operator profile, it may be saved through a key cycle only to that profile. In accordance with such an embodiment, once the paver 10 is shut down, the operator must go back through the interactive display 30 to re-activate their operator-specific profile in order for the lockout to function again.

In accordance with one embodiment of the disclosure, a message or indication on the interactive display 30 activates if an operator attempts to manipulate a function which has been locked out by the configurable lockout control 64. In accordance, with another embodiment of the disclosure, the lockout may only apply to manual functions and may not be applied to automation functions.

In accordance with another embodiment of the disclosure, the configurable lockout control 64 on each particular operator interface may only lockout the function for that particular side of the paver 10 (wherein dual or multiple interface designs are utilized). In accordance with this embodiment, the configurable lockout control 64 operates not as a function lockout but rather a control lockout. For example, in instances where a dual or multiple interface system is used, and wherein a function, such as the crown control, is a shared function between multiple operator interfaces, a lockout of the crown control 50 on, for example, the left operator interface 18 does not serve to lockout the crown control 50 on the right operator interface 20 and/or on a main panel.

Conversely, in another embodiment in accordance with the disclosure, the lockout control 64 may be configured as a function lockout. In accordance with this embodiment, the configurable lockout control 64 operates to lockout a particular function for the entire paver 10 regardless of whether or not there are other redundant controls for the same function located on different operator interfaces.

In an embodiment of the disclosure wherein the configurable lockout control 64 operates as a control lockout, a message may be programmed to be shown on the interactive display 30 that clearly indicates to the operator that only the specific control is locked out and, not the function for the entire paver 10. Conversely, in an embodiment of the disclosure wherein the configurable lockout control 64 operates as a function lockout for the entire paver 10, a message may be programmed to be shown on the interactive display 30 that clearly indicates to the operator that the function for the entire paver 10 is locked out and may not be adjusted by any redundant controls located on other operator interfaces.

### INDUSTRIAL APPLICABILITY

The present disclosure is applicable for use in connection with paving machines. In particular, the present disclosure is applicable for use in order to lockout certain functions on an operator interface used in paving machines such that such functions are not accidentally changed, adjusted, turned on/off, etc. while maintaining other functions in an adjustable condition for adjustments as necessary and/or desired on-the-fly.

In particular, it is noted that the configurable lockout control 64 disclosed herein may be used in connection with controls for a cold planer, rotary mixer, paver, compactor, or the like. More specifically, the configurable lockout control 64 may be used in connection with a screed apparatus 12 of the type generally used to perform the function of controlling the width, depth, initial finish, initial compaction, profile, etc. of an asphalt paving mat in an asphalt paving operation. However, there are many factors which can affect the effectiveness, efficiency, etc., of such a screed apparatus 12 used in such an application. For example, some of these factors include, but are not limited to, the paving speed, the head of material, the mix design, the mix temperature, air temperature, grade temperature, etc.

Accordingly, there are many reasons why multiple adjustments of a paving machine, or more specifically, the paver 10, and in particular the screed apparatus 12, may be necessary not only from job to job, but even from operator to operator, depending on the application. Accordingly, it can be seen that the ability to lockout controls and functions may be useful, but even more useful, would be the ability to lockout certain controls in certain applications (or by certain operators) while maintaining the flexibility to lockout other controls by other operators in other circumstances.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain functions is intended to indicate a lack of preference for those functions, but not to exclude such from the scope of the disclosure entirely unless otherwise indicated. All methods described herein can be performed in any suitable order unless otherwise indicated herein or otherwise clearly contradicted by context.

We claim:

1. A control for a paving machine comprising:
an operator interface having actuators associated therewith for controlling functions of a paving machine, the operator interface having a configurable lockout control associated therewith, wherein the configurable lockout control may be configured by an operator to select at least one function that is locked out of control by an associated actuator when the lockout control is activated.

2. The control for a paving machine of claim 1 further comprising an interactive display enabled to allow an operator to configure the configurable lockout control to lockout at least one of the functions controlled by the actuators by selecting at least one function to be locked out.

3. The control for a paving machine of claim 1 wherein the control is mounted at a paving-level.

4. The control for a paving machine of claim 1 wherein the control includes an indicator on the operator interface for indicating when the lockout control is activated.

5. The control for a paving machine of claim 2 wherein an operator is provided with a list of functions on the interactive display that the operator may select to lockout using the lockout control.

6. The control for a paving machine of claim 5 wherein the functions listed to be locked out are selected from the group consisting of: a left and/or right frame extension; a left and/or right towpoint; a left and/or right extender height; a left and/or right extender slope; a crown; an auger height; a conveyor reverse; or an auger reverse.

7. The control for a paving machine of claim 5 wherein activation of the lockout control by the operator locks out the selected functions.

8. The control for a paving machine of claim 7 wherein the operation of an actuator associated with a locked out function activates a message on the interactive display indicating to the operator that the operated actuator controls a locked out function.

9. The control for a paving machine of claim 5 wherein a selection of locked out functions may be saved as an operator-specific profile.

10. An operator interface for a paving machine comprising;
a control panel, the control panel having actuators thereon for controlling functions of a paving machine and including a configurable lockout control;
an interactive display;
wherein the interactive display is enabled to allow an operator to configure the configurable lockout control to lockout at least one of the functions controlled by the actuators by selecting at least one function to be locked out;
wherein when the configurable lockout control is activated, the selected functions are locked out for the operator interface; and
wherein when the configurable lockout control is deactivated, the selected functions may be controlled by the actuators on the control panel.

11. The operator interface for a paving machine of claim 10 wherein the operator interface is mounted at a paving-level.

12. The operator interface for a paving machine of claim 10 wherein the operator interface includes an indicator on the operator interface for indicating when the lockout control is activated.

13. The operator interface for a paving machine of claim 10 wherein the functions listed to be locked out are selected from the group consisting of: a left and/or right tractor frame extension; a left and/or right towpoint; a left and/or right extender height; a left and/or right extender slope; a crown; an auger height; a conveyor reverse; or an auger reverse.

14. The operator interface for a paving machine of claim 10 wherein the operation of an actuator associated with a locked out function activates a message on the interactive display indicating to the operator that the actuated actuator controls a locked out function.

15. The operator interface for a paving machine of claim 10 wherein the operation of an actuator associated with a locked out function activates a message on the interactive display indicating to the operator that the actuated actuator controls a locked out function but that the function is active for control by other controls.

16. The operator interface for a paving machine of claim 10 wherein a selection of locked out functions may be saved as an operator-specific profile.

17. The operator interface for a paving machine of claim 10 wherein the selected functions are saved from key cycle to key cycle.

18. The operator interface for a paving machine of claim 10 wherein the selected functions are cleared from key cycle to key cycle.

19. The operator interface for a paving machine of claim 10 wherein automation functions may not be selected to be locked out by the lockout control.

20. An operator interface for a paving machine comprising;
a control panel, the control panel having actuators thereon for controlling functions of a paving machine and including a configurable lockout control;
an interactive display;
wherein the interactive display is enabled to allow an operator to configure the configurable lockout control to lockout at least one of the functions controlled by the actuators selected from the group consisting of: a left and/or right tractor frame extension; a left and/or right towpoint; a left and/or right extender height; a left and/or right extender slope; a crown; an auger height; a conveyor reverse; or an auger reverse;
wherein when the configurable lockout control is activated, the selected functions are locked out for the operator interface and actuation of the actuators controlling the selected functions activates a message on the interactive display indicating to the operator that the actuated actuator controls a locked out function; and
wherein when the configurable lockout control is deactivated, the selected functions may be controlled by the actuators on the control panel.
